(19) United States
(12) Patent Application Publication
(10) Pub. No.: US 2025/0334452 A1
(43) Pub. Date: Oct. 30, 2025

(54) PASSIVE INFRARED SENSOR SENSITIVITY ADJUSTMENT DEVICE

(71) Applicant: Xiamen PVTECH Co., Ltd., Xiamen (CN)

(72) Inventors: RONGHUI WANG, Xiamen (CN); Hong Sheng Zhan, Xiamen (CN); Ren Zhen Zou, Xiamen (CN); Fuxing Lu, Xiamen (CN)

(73) Assignee: Xiamen PVTECH Co., Ltd., Xiamen (CN)

(21) Appl. No.: 19/186,649

(22) Filed: Apr. 23, 2025

(30) Foreign Application Priority Data
Apr. 30, 2024 (CN) 202410543531.9

(51) Int. Cl. G01J 5/06; G01J 5/90

(52) U.S. Cl. CPC G01J 5/06; G01J 5/90

(57) ABSTRACT

A passive infrared sensor sensitivity adjustment device includes a processing module, a sensitivity control module and a sensing function adjustment module. The processing module receives an input signal and generates a sensitivity control signal accordingly. The sensitivity control module is connected to the processing module, receives the sensitivity control signal, and generates a sensitivity adjustment signal accordingly. The sensing function adjustment module is connected to the processing module and the sensitivity control module, and receives the sensitivity adjustment signal and a sensing signal generated by the passive infrared sensor. The sensing function adjustment module adjusts a preset threshold value according to the sensitivity adjustment signal, and compares the sensing signal with the preset threshold value to generate a voltage signal. The processing module generates a start signal according to the voltage signal to activate the target device or not generate the start signal according to the voltage signal.

### BACKGROUND OF THE INVENTION

### 1. Field of the Invention

The present invention relates to a sensor sensitivity adjustment device, in particular to a passive infrared sensor sensitivity adjustment device.

### 2. Description of the Prior Art

A PIR (passive infrared) sensor is a passive infrared sensor that does not emit infrared radiation but detects infrared radiation emitted by moving targets (such as humans and animals) to generate a sensing signal. PIR sensors have been widely applied in lighting systems, alarm systems, and various other applications. However, currently available PIR sensors still have several deficiencies that need improvement. For instance, the sensitivity of currently available PIR sensors cannot be adjusted, making these sensors unsuitable for different application scenarios. For example, when the sensor is positioned far from the moving target, higher sensitivity is required. Conversely, when the sensor is closer to the target, lower sensitivity is preferable.

Furthermore, after prolonged use, the sensitivity of a PIR sensor may degrade. Due to the lack of a calibration mechanism in currently available PIR sensors, these sensors may become ineffective in detecting moving targets accurately.

### SUMMARY OF THE INVENTION

One embodiment of the present invention provides a passive infrared sensor sensitivity adjustment device includes a processing module, a sensitivity control module and a sensing function adjustment module. The processing module receives an input signal and generates a sensitivity control signal according to the input signal. The sensitivity control module is connected to the processing module, receives the sensitivity control signal, and generates a sensitivity adjustment signal according to the sensitivity control signal. The sensing function adjustment module is connected to the processing module and the sensitivity control module, and receives the sensitivity adjustment signal and a sensing signal generated by the passive infrared sensor. The sensing function adjustment module adjusts a preset threshold value according to the sensitivity adjustment signal, and compares the sensing signal with the preset threshold value to generate a voltage signal. The processing module generates a start signal according to the voltage signal to activate the target device or not generate the start signal according to the voltage signal.

In one embodiment, when the sensing signal is greater than or equal to the preset threshold value, the voltage signal generated by the sensing function adjustment module is at high level. The processing module generates the start signal according to the voltage signal to activate the target device.

In one embodiment, when the sensing signal is lower than the preset threshold value, the voltage signal generated by the sensing function adjustment module is at low level. The processing module does not generate the start signal.

In one embodiment, the sensing function adjustment module stores each of the sensing signals received thereby, and sequentially divides the most recently received preset number of the sensing signals into at least three groups. The time points of the sensing signals of each of the groups are adjacent to each other. The sensing function adjustment module calculates the average value of the intensities of the sensing signals in each of the groups, and fine-tunes the preset threshold value according to the average value of each of the groups.

In one embodiment, the groups include a first group, a second group, and a third group, and when the average value of the first group is less than the average value of the second group, and the average value of the second group is less than the average value of the third group, the sensing function adjustment module calculates a difference between the average value of the third group and the average value of the second group, and adjusts the preset threshold value according to a ratio of the difference to the average value of the third group.

In one embodiment, the sensing function adjustment module subtracts the ratio from 1 to generate an adjustment value, multiplies the adjustment value by the preset threshold value to generate an adjusted preset threshold value, and generates the voltage signal according to the adjusted preset threshold value.

In one embodiment, the passive infrared sensor sensitivity adjustment device further includes a power supply module connected to the processing module.

In one embodiment, the power supply module includes a rectifier circuit, a filter circuit, and a converter.

In one embodiment, the processing module is a microcontroller (MCU), a central processing unit (CPU), an application-specific integrated circuit chip (ASIC), or a field-programmable gate array (FPGA).

In one embodiment, the sensing function adjustment module is a microcontroller, a central processing unit, an application-specific integrated circuit chip, or a field-programmable gate array.

The passive infrared sensor sensitivity adjustment device in accordance with the embodiments of the present invention may have the following advantages:

(1) In one embodiment of the present invention, the passive infrared sensor sensitivity adjustment device includes a processing module, a sensitivity control module and a sensing function adjustment module. The processing module receives an input signal and generates a sensitivity control signal according to the input signal. The sensitivity control module is connected to the processing module, receives the sensitivity control signal, and generates a sensitivity adjustment signal according to the sensitivity control signal. The sensing function adjustment module is connected to the processing module and the sensitivity control module, and receives the sensitivity adjustment signal and a sensing signal generated by the passive infrared sensor. The sensing function adjustment module adjusts a preset threshold value according to the sensitivity adjustment signal, and compares the sensing signal with the preset threshold value to generate a voltage signal. The processing module generates a start signal according to the voltage signal to activate the target device or not generate the start signal according to the voltage signal. As described above, the passive infrared sensor sensitivity adjustment device integrates the sensitivity control module and the sensing function adjustment module to achieve sensitivity adjustment function. Thus, the user can adjust the sensitivity of the passive infrared sensor according to actual needs to meet different application requirements.
(2) In an embodiment of the present invention, the sensing function adjustment module of the passive infrared sensor sensitivity adjustment device can store each received sensing signal and sequentially divide the most recently received preset number of sensing signals into at least three groups. The times points of the sensing signals in each group are adjacent to each other. The sensing function adjustment module calculates the average value of the intensities of the sensing signals in each group and fine-tunes the preset threshold value according to the average value of each group. Via the above window fine-tuning mechanism (dividing multiple sensing signals into multiple sequential groups, where each group can be considered a window), the passive infrared sensor sensitivity adjustment device can adaptively and automatically adjust the sensitivity of the passive infrared sensor according to the aging state thereof so as to achieve high adjustment accuracy. Consequently, the passive infrared sensor can maintain a high detection accuracy to meet actual application needs.
(3) In an embodiment of the present invention, the circuit design of the sensitivity control module in the passive infrared sensor sensitivity adjustment device can implement multiple sensitivity adjustment levels for the user to choose from. The user can operate the sensitivity control module via an electronic device (such as a smartphone, tablet, or laptop) by running an application to select an appropriate sensitivity adjustment level. Therefore, the passive infrared sensor sensitivity adjustment device can meet different user needs to provide greater operational flexibility.
(4) In an embodiment of the present invention, the user can operate the sensitivity control module through an electronic device to select an appropriate sensitivity adjustment level. As a result, the passive infrared sensor sensitivity adjustment device is not only easy and convenient to use but also allows the user to perform sensitivity adjustments quickly without technical assistance. Therefore, the application of the passive infrared sensor sensitivity adjustment device can be comprehensive, which can conform to actual application needs.
(5) In an embodiment of the present invention, the passive infrared sensor sensitivity adjustment device can be integrated with currently available intelligent systems (such as intelligent home systems) to realize various intelligent applications. Consequently, the passive infrared sensor sensitivity adjustment device can enhance the functionality of currently available intelligent systems so as to align with future development trends.
(6) In an embodiment of the present invention, the design of the passive infrared sensor sensitivity adjustment device is simple, so the passive infrared sensor sensitivity adjustment device can achieve the desired effects without significantly increasing costs. Therefore, the passive infrared sensor sensitivity adjustment device offers high practicality.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a passive infrared sensor sensitivity adjustment device in accordance with a first embodiment of the present invention.

FIG. 2 is a schematic view of an operating state of the passive infrared sensor sensitivity adjustment device in accordance with the first embodiment of the present invention.

FIG. 3 is a circuit diagram of the passive infrared sensor sensitivity adjustment device in accordance with the first embodiment of the present invention.

FIG. 4 is a block diagram of a passive infrared sensor sensitivity adjustment device in accordance with a second embodiment of the present invention.

FIG. 5 is a flow chart of a passive infrared sensor sensitivity adjustment method in accordance with a third embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

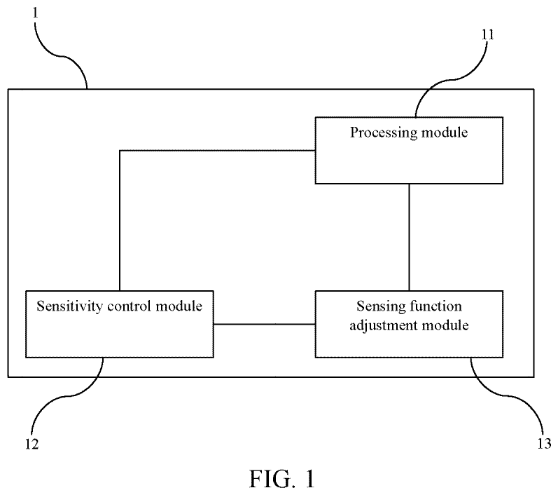

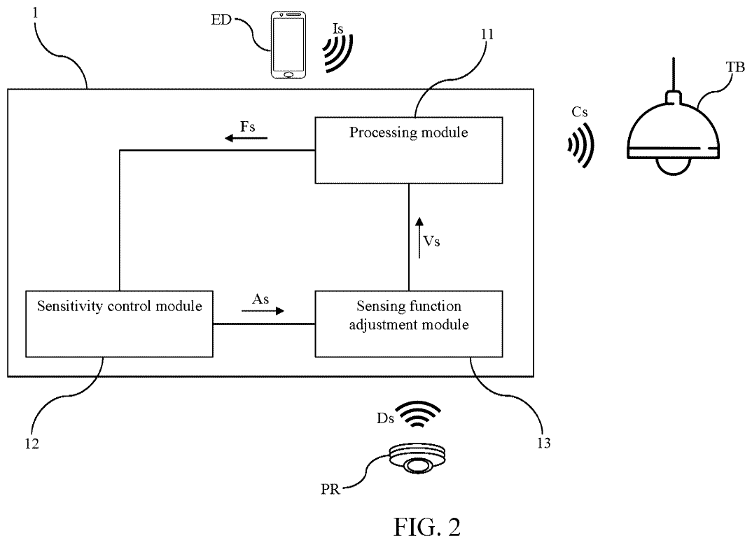

Please refer to FIG. 1 and FIG. 2. FIG. 1 is a block diagram of a passive infrared sensor sensitivity adjustment device in accordance with a first embodiment of the present invention. FIG. 2 is a schematic view of an operating state of the passive infrared sensor sensitivity adjustment device in accordance with the first embodiment of the present invention. As shown in FIG. 1, the passive infrared sensor sensitivity adjustment device 1 includes a processing module 11, a sensitivity control module 12, and a sensing function adjustment module 13.

The processing module 11 is connected to both the sensitivity control module 12 and the sensing function adjustment module 13, while the sensitivity control module 12 and the sensing function adjustment module 13 are also connected to each other. In one embodiment, the processing module 11 may be a microcontroller unit (MCU). In another embodiment, the processing module 11 may be a central processing unit (CPU), an application-specific integrated circuit (ASIC), a field-programmable gate array (FPGA), or other similar components. In one embodiment, the sensing function adjustment module 13 may be an MCU. In another embodiment, the sensing function adjustment module 13 may be a CPU, ASIC, FPGA, or other similar components.

The embodiment just exemplifies the present invention and is not intended to limit the scope of the present invention; any equivalent modification and variation according to the spirit of the present invention is to be also included within the scope of the following claims and their equivalents.

As shown in FIG. 2, the processing module 11 receives the input signal Is and generates the sensitivity control signal Fs according to the input signal Is. The user can operate an electronic device ED (such as a smartphone, tablet, or laptop) to execute an application that generates the input signal Is.

The sensitivity control module 12 receives the sensitivity control signal Fs and generates the sensitivity adjustment signal As accordingly.

The sensing function adjustment module 13 receives the sensitivity adjustment signal As. Then, the sensing function adjustment module 13 adjusts the preset threshold value according to the sensitivity adjustment signal As. When the passive infrared sensor PR detects a moving target (such as a human or an animal), the passive infrared sensor PR generates a sensing signal Ds and transmits the sensing signal Ds to the sensing function adjustment module 13. The sensing function adjustment module 13 compares the sensing signal Ds with the preset threshold value to generate a voltage signal Vs, which is then transmitted to the processing module 11.

Finally, the processing module 11 generates a start signal Cs according to the voltage signal Vs to activate or does not generate the start signal Cs according to the voltage signal Vs. If the sensing signal Ds is greater than or equal to the preset threshold value, the voltage signal Vs generated by the sensing function adjustment module 13 is at high level. At this time, the processing module 11 generates the start signal Cs according to the voltage signal Vs to activate the target device TB. If the sensing signal Ds is lower than the preset threshold value, the voltage signal Vs generated by the sensing function adjustment module 13 is at low level. At this time, the processing module 11 does not generate the start signal Cs. In this embodiment, the target device TB may be a lighting device. In another embodiment, the target device TB may also be any currently available electronic device or household appliance, such as an audio system, television, or alarm system. For example, if the distance between the passive infrared sensor PR and the moving target is relatively large, the user can increase the sensitivity of the passive infrared sensor PR. Conversely, if the passive infrared sensor PR is positioned closer to the moving target, the user can decrease the sensitivity of the passive infrared sensor PR.

After prolonged use, the passive infrared sensor PR may experience aging. The sensing function adjustment module 13 can execute a special window fine-tuning mechanism to adaptively and automatically adjust the sensitivity of the passive infrared sensor PR according to the aging state thereof. The sensing function adjustment module 13 stores each received sensing signal Ds and sequentially divides the most recently received preset number of sensing signals Ds into at least three groups. The time points of the sensing signals Ds of each group are adjacent to each other. The sensing function adjustment module 13 calculates the average value of the intensities of the sensing signals Ds in each group and fine-tunes the preset threshold value according to the average value of each group. For example, if the three groups include a first group, a second group, and a third group (but are not limited to three groups and can be adjusted as needed), the sensing function adjustment module 13 calculates the difference between the average values of the third and second groups when the average value of the first group is lower than that of the second group and the second group is lower than the third group. The sensing function adjustment module 13 then adjusts the preset threshold value according to the ratio of this difference to the third group's average value. The sensing function adjustment module 13 subtracts this ratio from 1 to obtain an adjustment value, which is multiplied by the preset threshold value to generate the adjusted preset threshold value. The voltage signal is generated according to this adjusted preset threshold value.

For instance, the sensing function adjustment module 13 may divide the most recently received 15 sensing signals Ds into three groups. Each group contains five sensing signals Ds from adjacent time points. That is to say, the first group has 5 sensing signals Ds, and the time points of these sensing signals Ds are adjacent to each other. The second group has 5 sensing signals Ds, and the time points of these sensing signals Ds are adjacent to each other. The third group has 5 sensing signals Ds, and the time points of these sensing signals Ds are adjacent to each other. The sensing function adjustment module 13 calculates the average value of the intensity of multiple sensing signals Ds in each group. If the average value of the first group is less than the average value of the second group, and the average value of the second group is less than the average value of the third group, the sensing function adjustment module 13 determines that the passive infrared sensor PR has undergone aging. At this time, the sensing function adjustment module 13 calculates the difference between the average value of the third group and the average value of the second group, and then calculates the ratio of this difference to the average value of the third group. Next, the sensing function adjustment module 13 subtracts the ratio from 1 to generate an adjustment value and multiplies the adjustment value by the preset threshold value to generate an adjusted preset threshold value. The sensing function adjustment module 13 then generates a voltage signal Vs according to the adjusted preset threshold value. For example, if the adjustment value is 0.9, the sensing function adjustment module 13 multiplies 0.9 by the preset threshold value to generate the adjusted preset threshold value and then generates the voltage signal Vs according to the adjusted preset threshold value.

As described above, in this embodiment, the passive infrared sensor sensitivity adjustment device 1 integrates the sensitivity control module 12 and the sensing function adjustment module 13 to achieve sensitivity adjustment function. The user can adjust the sensitivity of the passive infrared sensor PR according to actual needs to meet different application requirements.

Furthermore, in this embodiment, the sensing function adjustment module 13 can store each received sensing signal Ds and divide the most recent preset number of sensing signals Ds into at least three groups. The sensing function adjustment module 13 calculates the average value of each group and fine-tunes the preset threshold value accordingly. Through this window fine-tuning mechanism, the passive infrared sensor sensitivity adjustment device 1 can adaptively and automatically adjust the sensitivity of the passive infrared sensor PR according to the aging state thereof in order to achieve high adjustment accuracy. Consequently, the passive infrared sensor PR can maintain high detection accuracy to meet actual application needs.

In addition, in this embodiment, the circuit design of the sensitivity control module 12 can implement multiple sensitivity adjustment levels for the user to choose from. The user can operate the sensitivity control module 12 via an electronic device ED (such as a smartphone, tablet, or laptop) by running an application to select an appropriate sensitivity adjustment level. Therefore, the passive infrared sensor sensitivity adjustment device 1 can meet different user needs with a view to providing greater operational flexibility.

The embodiment just exemplifies the present invention and is not intended to limit the scope of the present invention; any equivalent modification and variation according to the spirit of the present invention is to be also included within the scope of the following claims and their equivalents.

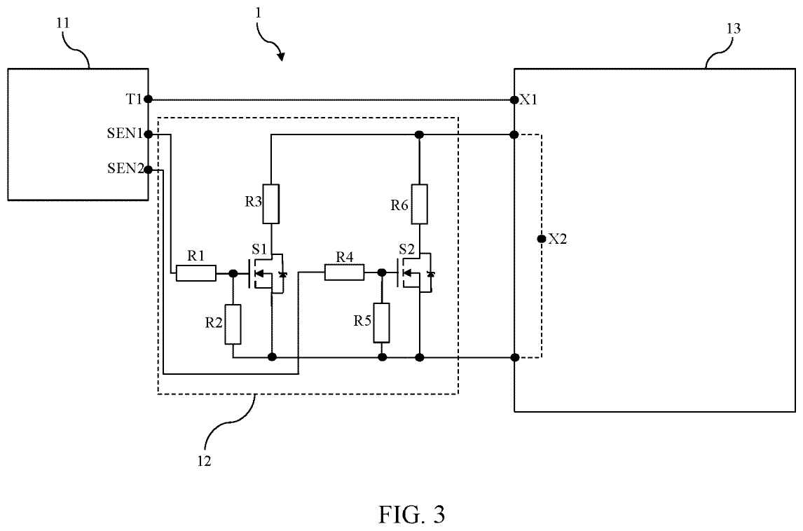

Please refer to FIG. 3, which is a circuit diagram of the passive infrared sensor sensitivity adjustment device in accordance with the first embodiment of the present invention. As shown in FIG. 3, the passive infrared sensor sensitivity adjustment device 1 includes a processing module 11, a sensitivity control module 12, and a sensing function adjustment module 13.

The processing module 11 includes a signal receiving pin T1, a first signal output pin SEN1, and a second signal output pin SEN2.

The sensing function adjustment module 13 includes a voltage output pin X1 and a sensitivity adjustment pin X2.

The sensitivity control module 12 includes two voltage divider circuits. The first voltage divider circuit comprises resistors R1 to R3 and a switch S1. The second voltage divider circuit comprises resistors R4 to R6 and a switch S2.

The processing module 11 outputs a sensitivity control signal Fs via the first signal output pin SEN1 and the second signal output pin SEN2. The sensitivity control module 12 receives the sensitivity control signal Fs, generates a sensitivity adjustment signal As according to the sensitivity control signal Fs, and inputs the sensitivity adjustment signal As to the sensitivity adjustment pin X2 of the sensing function adjustment module 13. The two voltage divider circuits of the sensitivity control module 12 can generate four different sensitivity adjustment levels. The voltage output pin X1 of the sensing function adjustment module 13 then outputs a voltage signal Vs to the signal receiving pin T1 of the processing module 11.

The above circuit design can be modified based on actual requirements. The sensitivity control module 12 can generate additional sensitivity adjustment levels, and the present invention is not limited to the specific embodiments described.

The embodiment just exemplifies the present invention and is not intended to limit the scope of the present invention; any equivalent modification and variation according to the spirit of the present invention is to be also included within the scope of the following claims and their equivalents.

It is worthy to point out that the sensitivity of currently available PIR sensors cannot be adjusted, making these sensors unsuitable for different application scenarios. For example, when the sensor is positioned far from the moving target, higher sensitivity is required. Conversely, when the sensor is closer to the target, lower sensitivity is preferable. Furthermore, after prolonged use, the sensitivity of a PIR sensor may degrade. Due to the lack of a calibration mechanism in currently available PIR sensors, these sensors may become ineffective in detecting moving targets accurately. By contrast, according to one embodiment of the present invention, the passive infrared sensor sensitivity adjustment device includes a processing module, a sensitivity control module and a sensing function adjustment module. The processing module receives an input signal and generates a sensitivity control signal according to the input signal. The sensitivity control module is connected to the processing module, receives the sensitivity control signal, and generates a sensitivity adjustment signal according to the sensitivity control signal. The sensing function adjustment module is connected to the processing module and the sensitivity control module, and receives the sensitivity adjustment signal and a sensing signal generated by the passive infrared sensor. The sensing function adjustment module adjusts a preset threshold value according to the sensitivity adjustment signal, and compares the sensing signal with the preset threshold value to generate a voltage signal. The processing module generates a start signal according to the voltage signal to activate the target device or not generate the start signal according to the voltage signal. As described above, the passive infrared sensor sensitivity adjustment device integrates the sensitivity control module and the sensing function adjustment module to achieve sensitivity adjustment function. Thus, the user can adjust the sensitivity of the passive infrared sensor according to actual needs to meet different application requirements.

According to one embodiment of the present invention, the sensing function adjustment module of the passive infrared sensor sensitivity adjustment device can store each received sensing signal and sequentially divide the most recently received preset number of sensing signals into at least three groups. The times points of the sensing signals in each group are adjacent to each other. The sensing function adjustment module calculates the average value of the intensities of the sensing signals in each group and fine-tunes the preset threshold value according to the average value of each group. Via the above window fine-tuning mechanism (dividing multiple sensing signals into multiple sequential groups, where each group can be considered a window), the passive infrared sensor sensitivity adjustment device can adaptively and automatically adjust the sensitivity of the passive infrared sensor according to the aging state thereof so as to achieve high adjustment accuracy. Consequently, the passive infrared sensor can maintain a high detection accuracy to meet actual application needs.

Also, according to one embodiment of the present invention, the circuit design of the sensitivity control module in the passive infrared sensor sensitivity adjustment device can implement multiple sensitivity adjustment levels for the user to choose from. The user can operate the sensitivity control module via an electronic device (such as a smartphone, tablet, or laptop) by running an application to select an appropriate sensitivity adjustment level. Therefore, the passive infrared sensor sensitivity adjustment device can meet different user needs to provide greater operational flexibility.

Further, according to one embodiment of the present invention, the user can operate the sensitivity control module through an electronic device to select an appropriate sensitivity adjustment level. As a result, the passive infrared sensor sensitivity adjustment device is not only easy and convenient to use but also allows the user to perform sensitivity adjustments quickly without technical assistance. Therefore, the application of the passive infrared sensor sensitivity adjustment device can be comprehensive, which can conform to actual application needs.

Moreover, according to one embodiment of the present invention, the passive infrared sensor sensitivity adjustment device can be integrated with currently available intelligent systems (such as intelligent home systems) to realize various intelligent applications. Consequently, the passive infrared sensor sensitivity adjustment device can enhance the functionality of currently available intelligent systems so as to align with future development trends.

Furthermore, according to one embodiment of the present invention, the design of the passive infrared sensor sensitivity adjustment device is simple, so the passive infrared sensor sensitivity adjustment device can achieve the desired effects without significantly increasing costs. Therefore, the passive infrared sensor sensitivity adjustment device offers high practicality. As described above, the passive infrared sensor sensitivity adjustment device according to the embodiments of the present invention can achieve great technical effects.

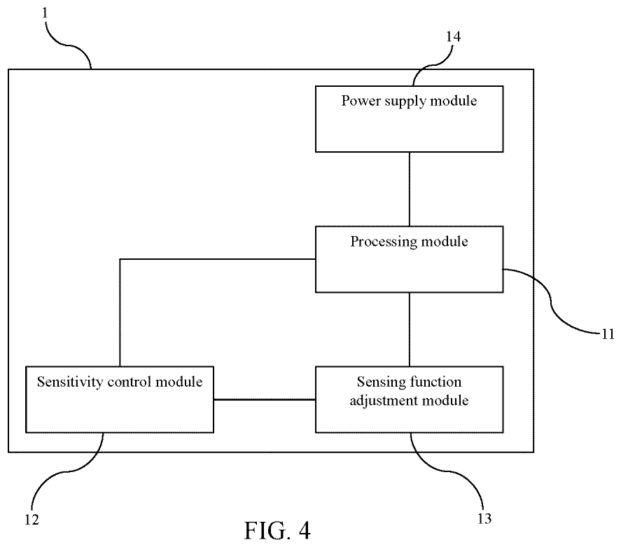

Please refer to FIG. 4, which is a block diagram of a passive infrared sensor sensitivity adjustment device in accordance with a second embodiment of the present invention. As shown in FIG. 4, the passive infrared sensor sensitivity adjustment device 1 includes a processing module 11, a sensitivity control module 12, and a sensing function adjustment module 13.

The processing module 11 is connected to the sensitivity control module 12 and the sensing function adjustment module 13, and the sensitivity control module 12 is also connected to the sensing function adjustment module 13. In one embodiment, the processing module 11 may be a microcontroller (MCU). In another embodiment, the processing module 11 may be a central processing unit (CPU), an application-specific integrated circuit (ASIC), a field-programmable gate array (FPGA), or other similar components. In one embodiment, the sensing function adjustment module 13 may be a microcontroller (MCU). In another embodiment, the sensing function adjustment module 13 may be a central processing unit (CPU), an application-specific integrated circuit (ASIC), a field-programmable gate array (FPGA), or other similar components.

Since the above components are similar to those in the previous embodiment, detailed descriptions are omitted here. The difference between this embodiment and the previous embodiment is that the passive infrared sensor sensitivity adjustment device 1, in this embodiment, further includes a power supply module 14. The power supply module 14 is connected to the processing module 11. The power supply module 14 includes a rectifier circuit, a filter circuit, a converter, and other necessary components to supply power to the processing module 11. Therefore, the passive infrared sensor sensitivity adjustment device 1 can be installed at an appropriate location within a building and connected to an external power source, such as a utility power. In another embodiment, the passive infrared sensor sensitivity adjustment device 1 may also include a battery, and the battery can supply power to the processing module 11.

The embodiment just exemplifies the present invention and is not intended to limit the scope of the present invention; any equivalent modification and variation according to the spirit of the present invention is to be also included within the scope of the following claims and their equivalents.

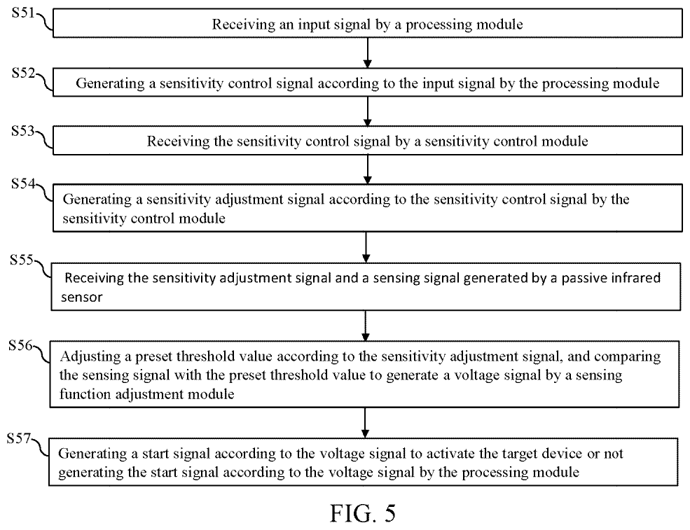

Please refer to FIG. 5, which is a flow chart of a passive infrared sensor sensitivity adjustment method in accordance with a third embodiment of the present invention. As shown in FIG. 5, the passive infrared sensor sensitivity adjustment method of this embodiment includes the following steps:

Step S51: receiving an input signal by a processing module.

Step S52: generating a sensitivity control signal according to the input signal by the processing module.

Step S53: receiving the sensitivity control signal by a sensitivity control module.

Step S54: generating sensitivity adjustment signal according to the sensitivity control signal by the sensitivity control module.

Step S55: receiving the sensitivity adjustment signal and a sensing signal generated by a passive infrared sensor.

Step S56: adjusting a preset threshold value according to the sensitivity adjustment signal, and comparing the sensing signal with the preset threshold value to generate a voltage signal by a sensing function adjustment module.

Step S57: generating a start signal according to the voltage signal to activate the target device or not generating the start signal according to the voltage signal by the processing module.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the passive infrared sensor sensitivity adjustment device includes a processing module, a sensitivity control module and a sensing function adjustment module. The processing module receives an input signal and generates a sensitivity control signal according to the input signal. The sensitivity control module is connected to the processing module, receives the sensitivity control signal, and generates a sensitivity adjustment signal according to the sensitivity control signal. The sensing function adjustment module is connected to the processing module and the sensitivity control module, and receives the sensitivity adjustment signal and a sensing signal generated by the passive infrared sensor. The sensing function adjustment module adjusts a preset threshold value according to the sensitivity adjustment signal, and compares the sensing signal with the preset threshold value to generate a voltage signal. The processing module generates a start signal according to the voltage signal to activate the target device or not generate the start signal according to the voltage signal. As described above, the passive infrared sensor sensitivity adjustment device integrates the sensitivity control module and the sensing function adjustment module to achieve sensitivity adjustment function. Thus, the user can adjust the sensitivity of the passive infrared sensor according to actual needs to meet different application requirements.

According to one embodiment of the present invention, the sensing function adjustment module of the passive infrared sensor sensitivity adjustment device can store each received sensing signal and sequentially divide the most recently received preset number of sensing signals into at least three groups. The times points of the sensing signals in each group are adjacent to each other. The sensing function adjustment module calculates the average value of the intensities of the sensing signals in each group and fine-tunes the preset threshold value according to the average value of each group. Via the above window fine-tuning mechanism (dividing multiple sensing signals into multiple sequential groups, where each group can be considered a window), the passive infrared sensor sensitivity adjustment device can adaptively and automatically adjust the sensitivity of the passive infrared sensor according to the aging state thereof so as to achieve high adjustment accuracy. Consequently, the passive infrared sensor can maintain a high detection accuracy to meet actual application needs.

Also, according to one embodiment of the present invention, the circuit design of the sensitivity control module in the passive infrared sensor sensitivity adjustment device can implement multiple sensitivity adjustment levels for the user to choose from. The user can operate the sensitivity control module via an electronic device (such as a smartphone, tablet, or laptop) by running an application to select an appropriate sensitivity adjustment level. Therefore, the passive infrared sensor sensitivity adjustment device can meet different user needs to provide greater operational flexibility.

Further, according to one embodiment of the present invention, the user can operate the sensitivity control module through an electronic device to select an appropriate sensitivity adjustment level. As a result, the passive infrared sensor sensitivity adjustment device is not only easy and convenient to use but also allows the user to perform sensitivity adjustments quickly without technical assistance. Therefore, the application of the passive infrared sensor sensitivity adjustment device can be comprehensive, which can conform to actual application needs.

Moreover, according to one embodiment of the present invention, the passive infrared sensor sensitivity adjustment device can be integrated with currently available intelligent systems (such as intelligent home systems) to realize various intelligent applications. Consequently, the passive infrared sensor sensitivity adjustment device can enhance the functionality of currently available intelligent systems so as to align with future development trends.

Furthermore, according to one embodiment of the present invention, the design of the passive infrared sensor sensitivity adjustment device is simple, so the passive infrared sensor sensitivity adjustment device can achieve the desired effects without significantly increasing costs. Therefore, the passive infrared sensor sensitivity adjustment device offers high practicality.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A passive infrared sensor sensitivity adjustment device, comprising:
a processing module configured to receive an input signal and generate a sensitivity control signal according to the input signal;
a sensitivity control module connected to the processing module, configured to receive the sensitivity control signal, and generate a sensitivity adjustment signal according to the sensitivity control signal; and
a sensing function adjustment module connected to the processing module and the sensitivity control module, and configured to receive the sensitivity adjustment signal and a sensing signal generated by the passive infrared sensor;
wherein the sensing function adjustment module is configured to adjust a preset threshold value according to the sensitivity adjustment signal, and compare the sensing signal with the preset threshold value to generate a voltage signal, and the processing module is configured to generate a start signal according to the voltage signal to activate the target device or not generate the start signal according to the voltage signal.

2. The passive infrared sensor sensitivity adjustment device as claimed in claim 1, wherein when the sensing signal is greater than or equal to the preset threshold value, the voltage signal generated by the sensing function adjustment module is at high level, and the processing module is configured to generate the start signal according to the voltage signal to activate the target device.

3. The passive infrared sensor sensitivity adjustment device as claimed in claim 2, wherein when the sensing signal is lower than the preset threshold value, the voltage signal generated by the sensing function adjustment module is at low level, and the processing module is configured to not generate the start signal.

4. The passive infrared sensor sensitivity adjustment device as claimed in claim 1, wherein the sensing function adjustment module is configured to store each of the sensing signals received thereby, and sequentially divide the most recently received preset number of the sensing signals into at least three groups, and time points of the sensing signals of each of the groups are adjacent to each other, wherein the sensing function adjustment module is configured to calculate an average value of intensities of the sensing signals in each of the groups, and fine-tune the preset threshold value according to the average value of each of the groups.

5. The passive infrared sensor sensitivity adjustment device as claimed in claim 4, wherein the groups comprise a first group, a second group, and a third group, and when the average value of the first group is less than the average value of the second group, and the average value of the second group is less than the average value of the third group, the sensing function adjustment module calculates a difference between the average value of the third group and the average value of the second group, and adjusts the preset threshold value according to a ratio of the difference to the average value of the third group.

6. The passive infrared sensor sensitivity adjustment device as claimed in claim 5, wherein the sensing function adjustment module is configured to subtract the ratio from 1 to generate an adjustment value, multiply the adjustment value by the preset threshold value to generate an adjusted preset threshold value, and generate the voltage signal according to the adjusted preset threshold value.

7. The passive infrared sensor sensitivity adjustment device as claimed in claim 1, further comprising a power supply module connected to the processing module.

8. The passive infrared sensor sensitivity adjustment device as claimed in claim 1, wherein the power supply module comprises a rectifier circuit, a filter circuit, and a converter.

9. The passive infrared sensor sensitivity adjustment device as claimed in claim 1, wherein the processing module is a microcontroller, a central processing unit, an application-specific integrated circuit chip, or a field-programmable gate array.

10. The passive infrared sensor sensitivity adjustment device as claimed in claim 1, wherein the sensing function adjustment module is a microcontroller, a central processing unit, an application-specific integrated circuit chip, or a field-programmable gate array.
